(19) United States
(12) Patent Application Publication
(10) Pub. No.: US 2005/0210505 A1
(43) Pub. Date: Sep. 22, 2005

(54) Instant interactive audio/video management system

(75) Inventors: Fu-Sheng Chiu, Taipei (TW); Chi-Yu Lai, Taipei (TW)

Correspondence Address: BACON & THOMAS, PLLC, 625 SLATERS LANE, FOURTH FLOOR, ALEXANDRIA, VA, 22314, US

(73) Assignee: ERA DIGITAL MEDIA CO., LTD., Taipei (TW)

(21) Appl. No.: 10/967,204

(22) Filed: Oct. 19, 2004

(30) Foreign Application Priority Data
Mar. 17, 2004 (TW) 093107154

(51) Int. Cl. H04N 7/16; H04N 7/18; G06F 13/00; H04N 5/445; G06F 3/00

(52) U.S. Cl. 725/43; 725/135; 725/80; 725/81

(57) ABSTRACT

The present invention discloses an instant interactive audio/video management system, which comprises a management program installed in an information processing device, and the management program integrates an instant video window, a text discussion window, a text broadcasting window and at least one media display window into a combined screen, so that the information processing device can send the combined screen to a terminal device, and the terminal device can show the combined screen. Therefore, a user of the terminal device can see the combined screen and the windows can display information directly from different sources.

### FIELD OF THE INVENTION

The present invention relates to an instant interactive audio/video management system, more particularly to an instant interactive audio/video management system having a management program installed in an information processing device for integrating an instant video window, a text discussion window, a text broadcasting window and at least one media display window into a combined screen and showing the combined screen and displaying information directly from different sources.

### BACKGROUND OF THE INVENTION

At present, our world has entered into a new era with blooming information, various high-tech products and network information products derived from the computer are developed very quickly, not only shortening the time and distance between people, but also becoming an integral part of our life, which can be considered as a central nervous system of our society that has a broad coverage. In the past, we had to spend much time and costs before we could meet with friends and relatives in other places. Now, with the network that shortens the distance between people, the network audio/video multifunctional communication method allows us to send our images and sound to places all over the world. As the information era has arrived, Internet has become a necessary path for information distributions.

As described previously, the fast development of Internet in these years further provides various multimedia services including the transmission of voices, pictures and dynamic videos in addition to the transmission of traditional emails, so that the general public can easily obtain plentiful and diversified information services from this channel. Thus, logging on a network has daily life, and the network product manufacturers also design various high-speed network devices such as cable modem or asymmetric digital subscriber line (ADSL) modem to cope with the trend and improve the transmission rate of the network. Some network product manufacturers also design various network peripherals such as the Voice over IP (VoIP) device to provide consumers a telecommunication service over the network in order to greatly save the consumer's expenditure for long-distance calls or international communication costs, or a Video on Demand (VoD) which is a technology allowing consumers to select their desired movies from the video server anytime and play the movie instantly. Since the interactive video on demand technology includes image and sound, therefore it is very suitable for the media broadcast industry, which can achieve the purpose of allowing consumers to freely select their desired information and having the interactive effect. Thus, it is foreseeable that the video on demand will progressively become very popular in the future.

However, not too many channels in the present media broadcast industry converts their audio/video signals into digital television signals, so that the receiving end with the installation of a set-top-box can give a high-resolution screen by the digital television signals, and program productions and playbacks still remain at the traditional production stage and cannot provide actual digital interactive services. The so-called digital interactive mode of the digital interactive service refers to the playback process fully controllable by the audience. In the meantime, many people can play video games, set up a request for a movie and have cross-talk services such as the distance learning. For example, the present live show usually takes the recording and playback in a studio. If the program is opened for call-ins, then the audience at the receiving end can dial a direct call for an instant dialogue, but the host/hostess in the studio, the audience at the scene, and staffs in the control room of the studio are unable to see the viewing audience. Therefore, the host/hostess, control staff, audience at the scene and the call maker do not have good interactions and may adversely affect the call-in effect. Further, the staffs in the control room cannot filter or select the viewing audience, such that the program may proceed with unnecessary disturbances.

If a live program can be conducted by the digital interactive service method, then the staffs in the control room can effectively control the situation of the viewing audiences, such that the images of the viewing audience can be transmitted to the scene for instant dialogues, and good interactions with instant images and sounds among the host/hostess in the studio, the audiences at the scene and the viewing audience can be achieved in order to enhance the effects of the program. Therefore, the way of using digital interactive service in the media broadcast industry demands immediate attention.

### SUMMARY OF THE INVENTION

The primary objective of the present invention is to provide an instant interactive audio/video management system, which comprises a management program installed in an information processing device, and such management program integrates an instant video window, a text discussion window, a text broadcasting window and at least one media display window into a combined screen, so that the information processing device can send the combined screen to a terminal device, and the terminal device can show the combined screen. Therefore, a user of the terminal device can see the combined screen and the windows can display information directly from different sources.

The above and other objects, features and advantages of the present invention will become apparent from the following detailed description taken with the accompanying drawing.

### BRIEF DESCRIPTION OF THE DRAWINGS

FIG. 1 is a view of the structure of the present invention.

FIG. 2 is a view of the instant interactive screen of the combine multimedia according to the present invention.

FIG. 3 is a view of the text talk management screen according to the present invention.

FIG. 4 is a view of the text broadcasting control according to the present invention.

FIG. 5 is a view of the video management screen according to the present invention.

FIG. 6 is a view of the instant announcement screen according to the present invention.

FIG. 7 is a view of the instant video information screen according to the present invention.

### DETAILED DESCRIPTION OF THE PREFERRED EMBODIMENTS

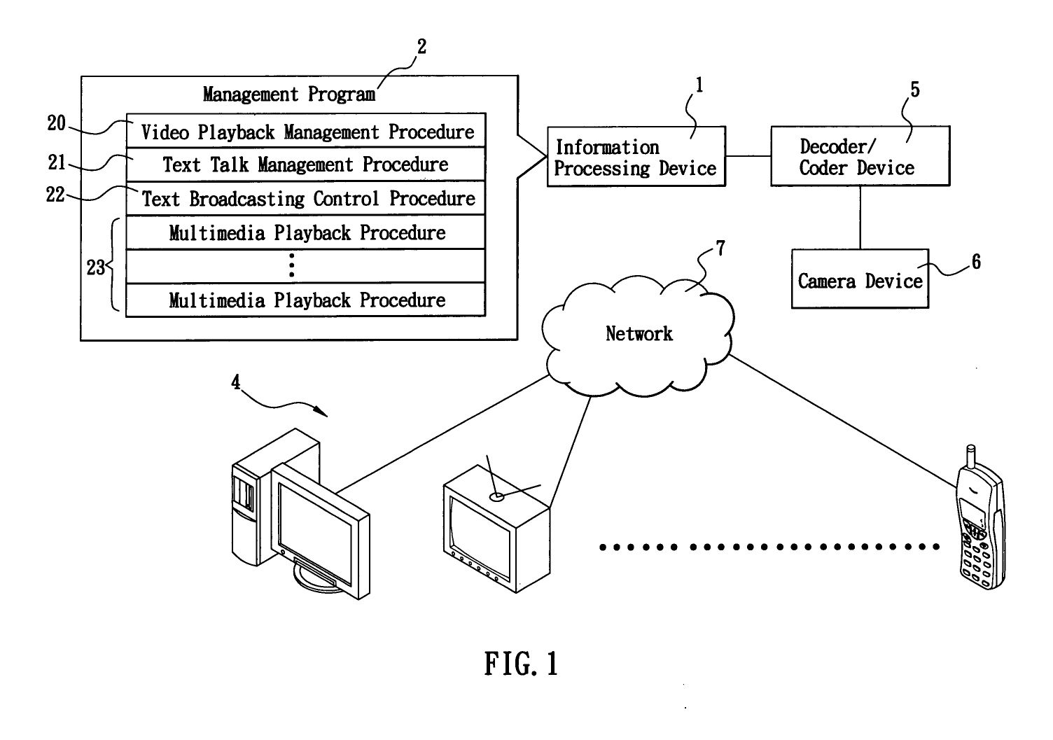

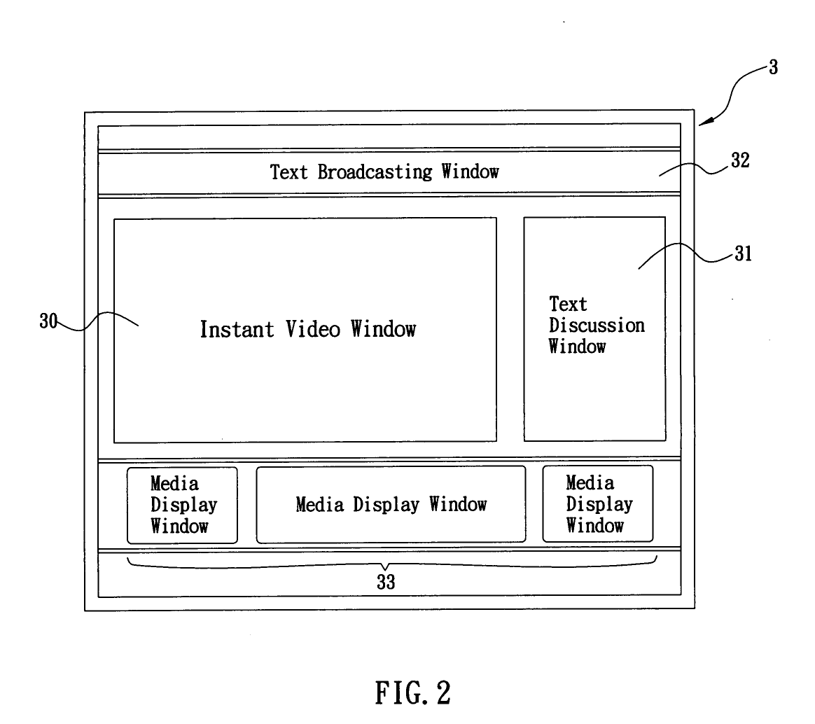

Please refer to FIGS. 1 and 2 for an instant interactive audio/video management system according to the present invention. In the figures, an information processing device 1 (such as a computer) comprises a management program 2, and the management program 2 comprises a video playback management procedure 20, a text talk management procedure 21, a text broadcasting control procedure 22 and at least one multimedia playback procedure 23, such that after the management program 2 is run, the foregoing procedure will be started, so that the video playback management procedure 20 generates an instant video window 30 and the text talk management procedure 21 generates a text discussion window 31, and the text broadcasting procedure 22 generates a text broadcasting window 32, and these multimedia playback procedures 23 generate a multimedia display window 33 individually. The management program 2 can integrate the instant video windows 30, text discussion window 31, text broadcasting window 32 and multimedia display windows 33 into a combined screen 3. Therefore, the information processing device 1 can send the combined screen 3 to at least one terminal device 4 (such as a computer, a television or a handset, etc), and the terminal device 4 can play the combined screen 3, so that the users of the terminal device 4 can see all kinds of information of each window of the combined screen 3, and such arrangement can solve the problem of the traditional terminal device requiring the switches between screens and the shortcoming of unable to achieve the instant audio/video interactive effect.

In a preferred embodiment of the present invention, the information processing device 1 is connected to a decoder/encoder device 5, and the decoder/encoder 5 is connected to at least one camera device 6, so that the decoder/encoder device 5 can convert the audio/video signals recorded by the camera device 6 into an instant video signal receivable by the video playback management procedure 20 and the video playback management procedure 20 can process one of the instant video signals and generates the instant video window 30.

The information processing device 1 according to the preferred embodiment of the invention is connected directly or indirectly to the terminal device 4 through a network 7 (such as Internet, telecommunication network or satellite network), so that the information processing device 1 can receive the text information inputted into the terminal device 4 and drive the text talk management procedure 21 to process such text data and generate the text discussion window 31. The method of displaying the text discussion window 31 in the terminal device adopts the technical measures commonly used in the chartrooms of different websites, and thus will not be described here.

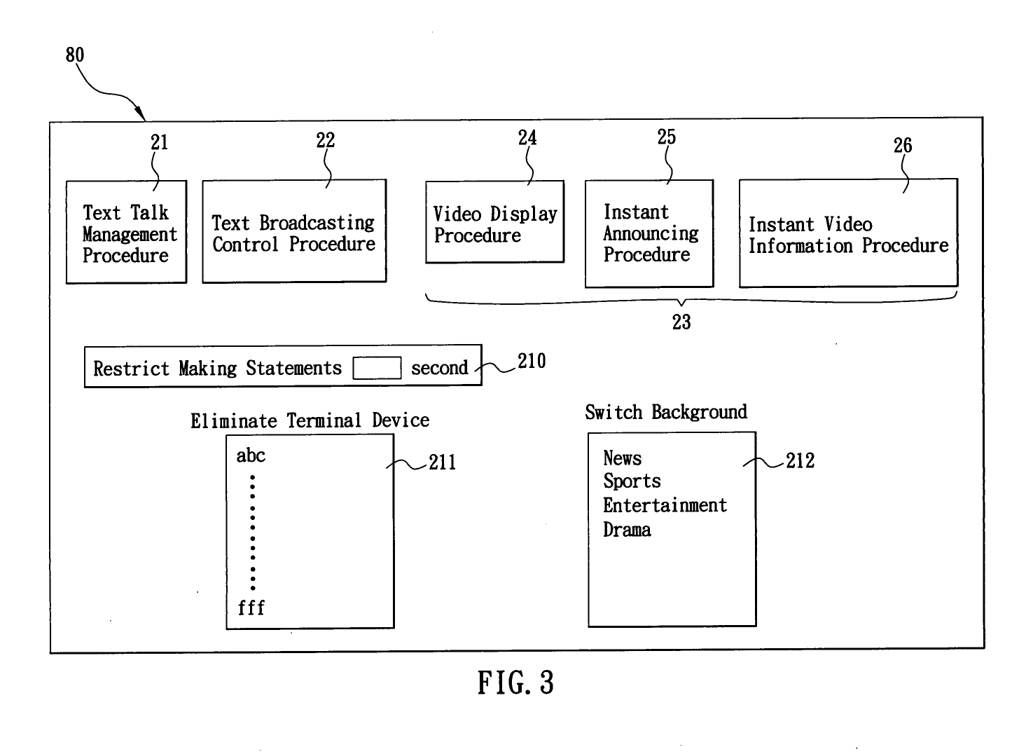

Please refer to FIG. 3 for the text talk management procedure 21 according to the present invention comprises a restricted speech option 210, a terminal device elimination option 211 and a background switch option 212, such that after the text talk management procedure 21 is executed, the information processing device 1 can show the text talk management screen 80, and the text talk management screen 80 includes the restricted speech option, terminal device elimination option 211 and background switch option 212; wherein the restricted speech option 210 can set up the time interval for each terminal device 4 to send out the text data and avoid the text discussion window 31 from repeatedly showing the text data from the same terminal device 4 within a short time. After the terminal device elimination option 211 is executed, the manager of the information processing device 1 runs the terminal device elimination option 211 to interrupt the connection status with the information processing device 1 if the terminal device 4 sends out an improper text data, so that the terminal device 4 cannot send the text data to the information processing device 1. After the background switch option 212 is executed, the information processing device 1 selects an appropriate background image in the text discussion window 31.

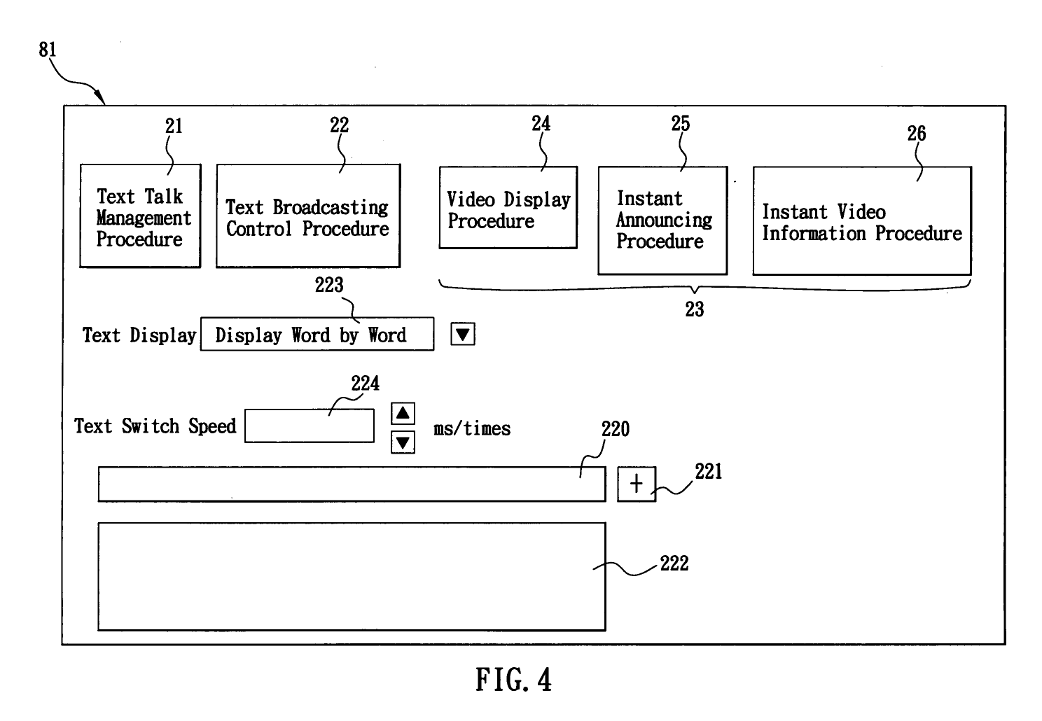

Please refer to FIG. 4 for the text broadcasting control procedure 22 according to a preferred embodiment of the invention, which comprises a text content option 220, an add option 221, an all option 222, a text display option 223 and a text switch speed option 224, so that after the text broadcasting control procedure 22 is executed, the information processing device 1 can produce a text broadcasting control screen 81, and the text broadcasting control screen 81 individually shows the text content option 220, the add option 221, the all option 222, the text switch speed option 224 and the text display option 223; wherein the text option 220 can input text data, and the add option 221 adds the text data inputted in the text option 220 to the next row of the all option 222. The all option 222 can display every row of text data added by the add option 221, and the text display option 223 comprises a plurality of text playback formats (such as a word-by-word display format and a row-by-row display format) for user's choice to control all text display methods in the all option 222, and the text switch speed option 224 controls the playback speed of the text data in the all option 222 having that particular text playback format, so that the text broadcasting control procedure 22 shows all of the text data in the all option 222 with different formats in the text broadcasting window 32.

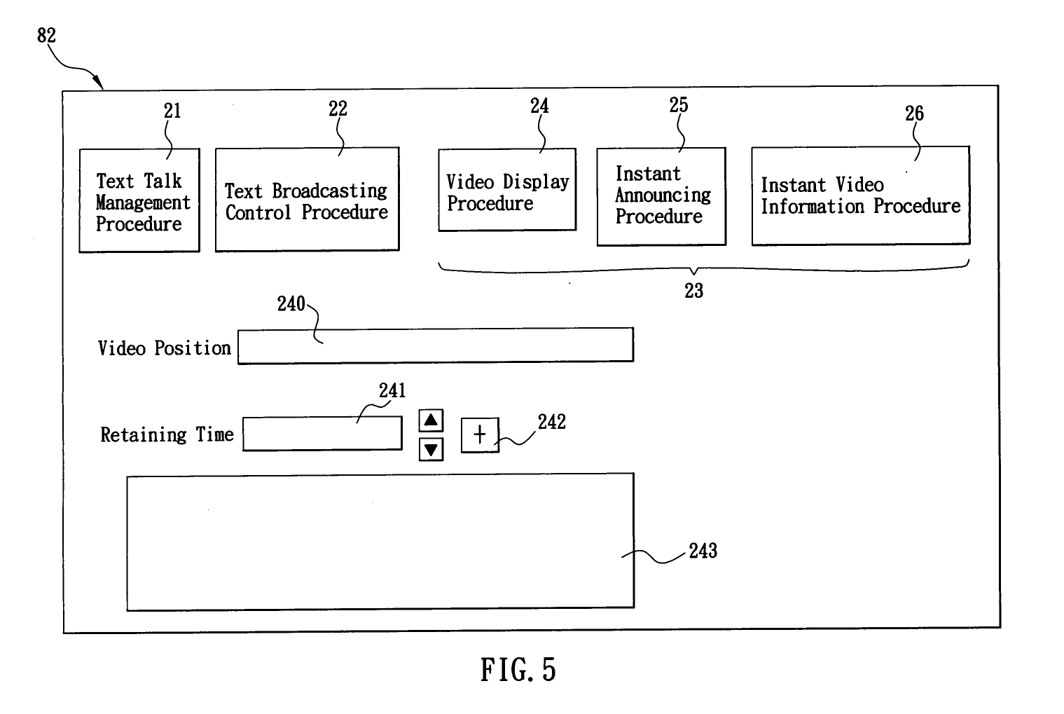

Please refer to FIG. 5 for the multimedia playback procedure 23 according to this embodiment, which comprises a video display procedure 24, an instant announcement procedure 25, and an instant video information procedure 26; wherein the video display procedure 24 comprises a video position option 240, an image retaining time option 241, an add video option 242 and an all video position option 243, so that after the video display procedure 24 is run, the information processing device 1 produces a video management screen 82, which can show the video position option 240, the image retaining time option 241, the add video option 242 and the all video position option 243. The video position option 240 can input a video source position, and the video image retaining time option 241 can set the video display time for the video source position, and the add video option 242 can add the video source position to the all video position option 243. Therefore, one of the media display windows 33 will display the images at the video source positions in sequence according to the all video source positions in the all video position option 243.

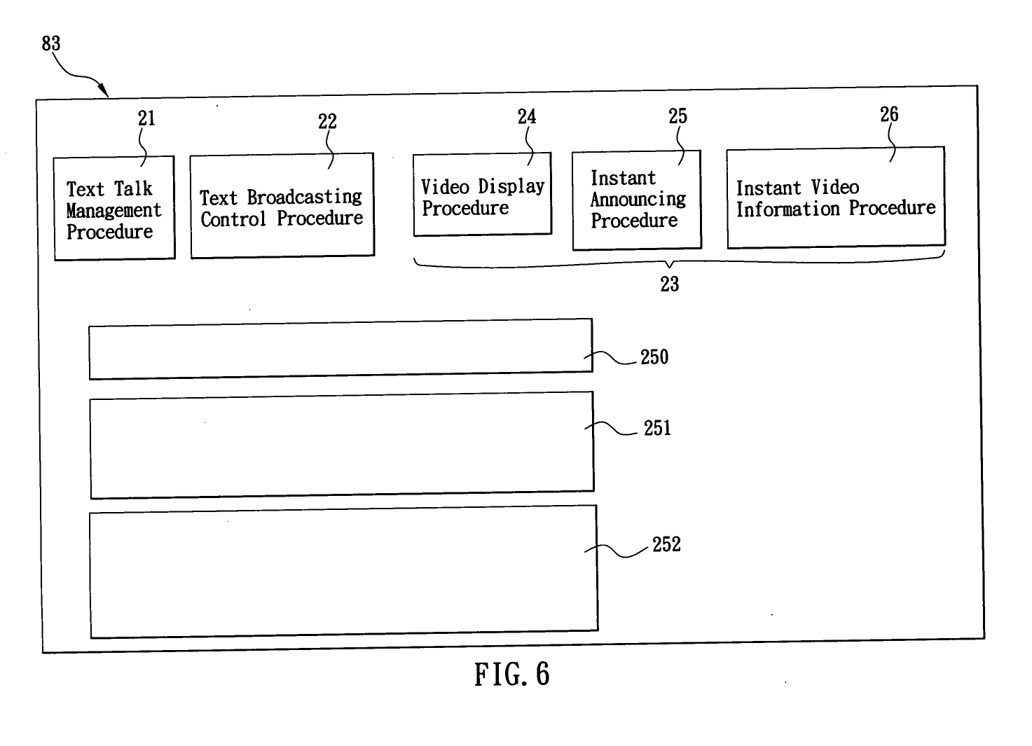

Please refer to FIG. 6 for the instant announcement procedure 25 which comprises a reply message option 250, a present message option 251 and a text discussion option 252, so that after the instant announcement procedure 25 is executed, the information processing device 1 generates an instant announcement screen 83. The instant announcement screen 83 can show the reply message option 250, and the current message option 251 and the text discussion option 252; wherein the reply message option 250 can input a reply message, and the current message option 251 can show all reply messages. The text discussion option 252 can show the data in the text discussion window 31. Therefore, all reply messages of another media display window 33 can be displayed in sequence in another media display window 33, such that the terminal device 4 can receive the signal replied by the user of the information processing device 1.

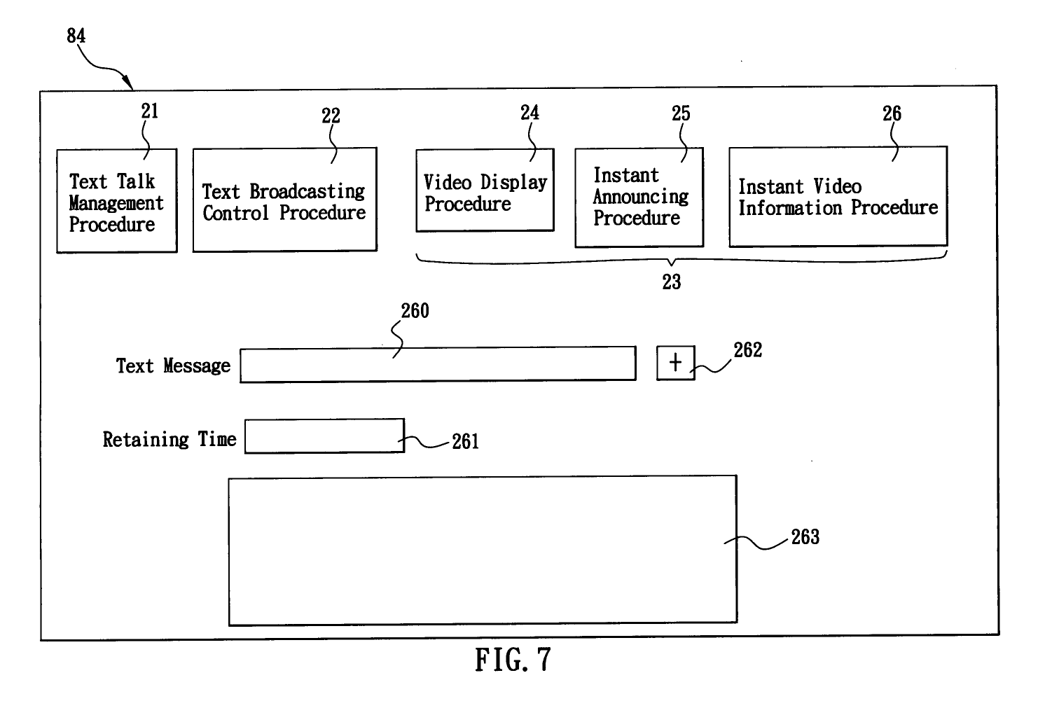

Please refer to FIG. 7 for the instant video information procedure 26, which comprises a text information option 260, a text retaining time option 261, an add text option 262 and an all text option 263, such that after the instant video information procedure 26 is run, the information processing device 1 can produce an instant video information screen 84, and the instant video information screen 84 can show the text information option 260 can input the playback content of the text data of the instant video window 30. The text retaining time option 261 can set the display time of the text data, and the text data inputted by the add text option 260 is added into the all text option 263, such that all text data can be displayed in another media display window 33 according to the all text option 263.

From the description above, the combined screen 3 comprises an instant video window 30, a text discussion window 31, a text broadcasting window 32 and a plurality of media display windows 33. These windows individually adopt different control procedures to obtain data from different sources, so that the users of the terminal device 4 no longer need to repeatedly switch between different windows anymore. As to the production of live shows, the instant video window 30 can provide a video playback area in the studio, and the text discussion window 31 serves as an instant discussion area for the program audience and the text playback window 32 serves as the instant message playback area. Further, the media display windows 33 serves as an area for displaying the images of the audience and the reply from the program producer. Each option can interrupt the connection between the terminal device 4 and the information processing device 1 for controlling and preventing improper actions of the terminal device 4 from being shown on the screen.

While the invention has been described by means of specific embodiments, numerous modifications and variations could be made thereto by those skilled in the art without departing from the scope and spirit of the invention set forth in the claims.

1. An instant interactive audio/video management system, having an information processing device coupled selectively in a direct and an indirect connection with at least one terminal device, and said information processing device comprising a management program, and said management program comprising an video display management procedure, a text talk management procedure, a text broadcasting control procedure and at least one multimedia playback procedure, such that after said management program being executed, the procedure of said management program comprising the steps of:
generating an instant video window by said video playback management procedure;
generating a text discussion window by said text talk management procedure;
generating a text broadcasting window by said text broadcasting control procedure;
generating a multimedia display window by said multimedia playback procedure;
said management program converting said instant video window, text discussion broadcasting window and said multimedia display window into a combined screen; and
said information processing device sending said combined screen to said each terminal, such that said terminal device plays said combined screen and said terminal device shows said information from different sources on said combined screen.

2. The system of claim 1, wherein said information processing device is coupled to a decoder/encoder device, and said decoder/encoder device is coupled to at least one camera device, such that said decoder/encoder device converts an audio/video signal created by said camera device into an instant video signal acceptable by said video playback management procedure, and said video playback management procedure processes one of said instant video signals and generate said instant video window.

3. The system of claim 1, wherein said text talk management procedure comprises a restricted speech option, a terminal device elimination option and a background switch option, such that after said text talk management procedure is executed, said information processing device shows a text talk management screen and said text talk management screen comprises a restricted speech option a terminal device elimination option and a background switch option, such that the procedure of said text talk management procedure comprises the steps of:
said restricted speech option setting up a time interval for sending out a text data from said each terminal device;
an information processing device manager executing said terminal device elimination option being used to interrupt the connection between one of said terminal devices and said information processing device after said terminal device elimination option being executed; and
said information processing device selecting an appropriate background image in said text discussion area after said background switch option being executed.

4. The system of claim 1, wherein said text broadcasting procedure comprises a text content option, an add option, an all option, a text display option and a text switch speed option, such that said information processing device generates a text broadcasting control screen, and said text broadcasting control screen individually shows said add option, said all option, said text display option and said text switch speed option after said text broadcasting control procedure is executed, and the procedure of said options comprises the steps of:
adding a text data inputted from said text data input area into the next row of said all option;
said all option displaying every row of said added text data;
said text display option comprising a plurality of text playback formats for user's choice to control the display method of all text in said all option;
said text switch speed option controlling the playback speed of said text data in said text playback format in said all option, such that said text broadcasting control procedure is capable of showing all text data in said all option on said text broadcasting window.

5. The system of claim 1, wherein said multimedia playback procedure comprises a video position option, a video retaining time option and an add video option such that after said video display procedure is executed, said information processing device generates a video management screen, and said video management screen displays said video position option, said video retaining time option, said add video option and said all video position option, and the control procedure of said options individually comprises the steps of:
inputting a video source position by said video position option;
setting a video display time for said video source position by said video retaining time option; and
said add video option adding said video source position into said all video position option, such that an image of said video source position is displayed on one of said media display windows according to said display time of all video source position in said all video position option.

6. The system of claim 1, wherein said multimedia playback procedure comprises an instant announcement procedure, and said instant announcement procedure individually comprises a reply message option, a current message option and a text discussion option, such that after said instant announcement procedure is executed, said information processing device generates an instant announcement screen and said instant announcement screen shows said reply message option, said current message option and said text discussion option, and the control procedure of said options individually comprises the steps of:
inputting a reply message from said reply message option;
displaying all of said reply messages from said current message option; and
displaying data onto said text discussion window by said text discussion option, thereby said terminal device receives a reply signal from a user of said information processing device and display all reply messages in said current message option in sequence onto another media video window.

7. The system of claim 1, wherein said multimedia playback procedure comprises an instant video information procedure, and said instant video information procedure comprises a text message option, a text retaining time option, an add text option and an all text option, such that after said instant video information procedure is executed, said information processing device generates an instant video information screen and said instant video information screen shows said text information option, said text retaining time option and said all text option, and the control procedure of said option individually comprises the steps of:
inputting a text data related to the content of said playback by said text information option;
setting a display time for said text data by said text retaining time option;
adding a text data inputted from said text information option by said add text option into said all text option, so that all of said text data in said all text option are shown onto another multimedia display window.
